(19) United States
(12) Patent Application Publication
(10) Pub. No.: US 2018/0136929 A1
(43) Pub. Date: May 17, 2018

(54) CONTENT DRIVEN AUTOMATED UPGRADE OF RUNNING WEB APPLICATIONS IN ON-PREMISE ENVIRONMENTS

(71) Applicant: International Business Machines Corporation, Armonk, NY (US)

(72) Inventors: Aaron O. Bauer, Berkeley, CA (US); Peter B. Loer, Berkeley, CA (US); Jeremy S. Spiegel, San Francisco, CA (US)

(21) Appl. No.: 15/467,473

(22) Filed: Mar. 23, 2017

Related U.S. Application Data
(60) Provisional application No. 62/422,471, filed on Nov. 15, 2016.

(51) Int. Cl. G06F 9/445; G06F 9/44; H04L 29/08

(52) U.S. Cl. CPC G06F 8/67; H04L 67/02; G06F 8/71

(57) ABSTRACT

An enterprise web application management system includes a cloud computing network having a WebApp database to store WebApp code. An on-premise local computing network is remotely located from the cloud computing network. The on-premise local computing network runs a current WebApp based on a current WebApp code, and communicates with the cloud computing network to determine whether the cloud computing network stores an updated version of the current WebApp code. The on-premise local computing network automatically downloads the updated version of the WebApp code from the cloud computing network in response to detecting that the updated version is stored at the cloud computing network, and locally stores the updated version of the WebApp code. The on-premise local computing network automatically spins up a new WebApp based on the updated version of the WebApp code in response to locally storing the updated version of the WebApp code.

### CROSS-REFERENCE TO RELATED APPLICATIONS

The present application claims priority to U.S. Provisional Application No. 62/422,471, filed on Nov. 15, 2016, the contents of which are incorporated by reference herein in its entirety.

### BACKGROUND

The present invention relates to on-premise enterprise web applications, and more particularly, to managing the currency of enterprise web applications installed at an on-premise local environment.

In recent years, there has been an industry shift to employ cloud-based services to manage various business and company information technology systems in a cloud-based environment due, in part, because these cloud-based services provide convenient network management services such as smoothly rolling out network software updates and software installations.

Some companies, such as those in the banking, insurance, and medical industries still may find it desirable to utilize on-site local environments due, in part, to increased security with respect to cloud-based environments. The employment of on-site local environments, however, typically creates a loss in network management convenience. For example, managing the currency of on-premise enterprise web applications installed on-premise is a time-consuming process for business organizations. For instance, on-premises enterprise web application management requires staying informed of the latest updates and planning and staffing a transition for minimal outages.

### SUMMARY

According to a non-limiting embodiment, an enterprise web application management system includes a cloud computing network having a web application (WebApp) database configured to store WebApp code. An on-premise local computing network is remotely located from the cloud computing network. The on-premise local computing network runs a current WebApp based on a current WebApp code, and is configured to electrically communicate with the cloud computing network to determine whether the cloud computing network stores an updated version of the current WebApp code. The on-premise local computing network is also configured to automatically download the updated version of the WebApp code from the cloud computing network in response to detecting that the updated version is stored at the cloud computing network, and locally store the updated version of the WebApp code at the on-premise local computing network. The on-premise local computing network is also configured to automatically spin up a new WebApp based on the updated version of the WebApp code in response to locally storing the updated version of the WebApp code at the on-premise local computing network.

According to another non-limiting embodiment, an on-premise local computing network is configured to manage concurrency of an on-premise web application (WebApp). The on-premise local computing network comprises an electronic WebApp gatherer controller and an electronic application monitor controller. The WebApp gatherer is configured to electrically communicate with a WebApp database installed in a cloud computing network located remotely from the on-premise local computing network, and determine whether the WebApp database stores an updated version of a WebApp code. In response to detecting the updated version of the WebApp code, the WebApp gather automatically transfers the updated version of the WebApp code from the cloud computing network to the on-premise local computing network without manual intervention. The electronic application monitor controller is configured to automatically determine whether the updated version of the WebApp code is locally stored on the on-premise local computing network. In response to detecting local storage of the updated version of the WebApp code, the application monitor controller automatically spins up the new WebApp without manual intervention.

According to another non-limiting embodiment, a method of managing concurrency of an on-premise web application (WebApp) running on an on-premise local computing network comprises storing WebApp code in a WebApp database of a cloud computing network. The method further comprises establishing signal communication between the cloud computing network and an on-premise local computing network remotely located from the cloud computing network, and running a current WebApp based on a current WebApp code at the on-premise local computing network. The method further comprises determining whether the cloud computing network stores an updated version of the current WebApp code. In response to determining the updated version is stored at the cloud computing network, the updated version of the WebApp code is automatically transferred to the on-premise local computing network and is locally stored at the on-premise local computing network. The method further comprises automatically spinning up a new WebApp based on the updated version of the WebApp code in response to locally storing the updated version of the WebApp code at the on-premise local computing network.

### BRIEF DESCRIPTION OF THE DRAWINGS

FIG. 1A shows a computer system/server which is applicable to implement various non-limiting embodiments of the present invention;

FIG. 1B represents the cloud computing environment according to one embodiment of the present disclosure.

FIG. 1C represents an abstract model layer according to one embodiment of the present disclosure.

FIG. 2 shows a basic topology of a cloud-side applied in the present disclosure;

FIG. 3 illustrates a basic topology of a cloud-side network according to a non-limiting embodiment of the present disclosure;

FIG. 4 is a block diagram of an enterprise web application management system according to a non-limiting embodiment; and

FIG. 5 is a flow diagram illustrating a method of managing concurrency of on-premise enterprise web applications installed on-premise is illustrated according to a non-limiting embodiment.

### DETAILED DESCRIPTION

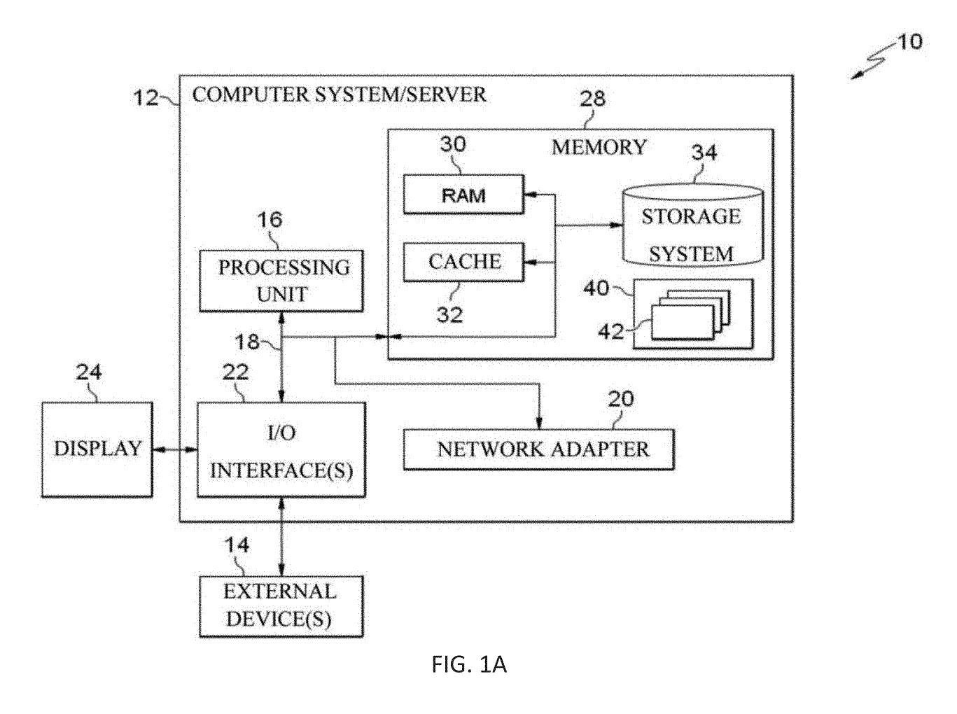

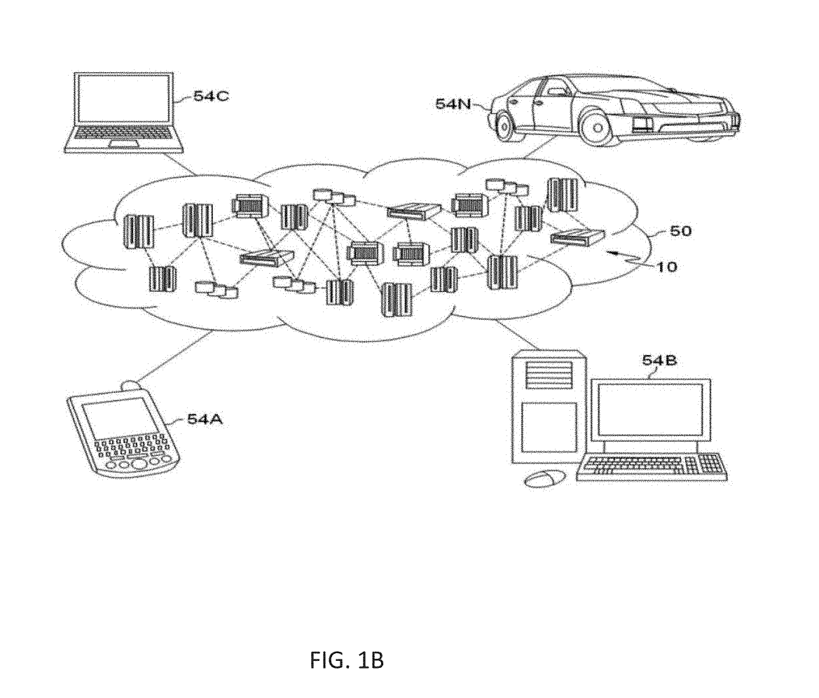

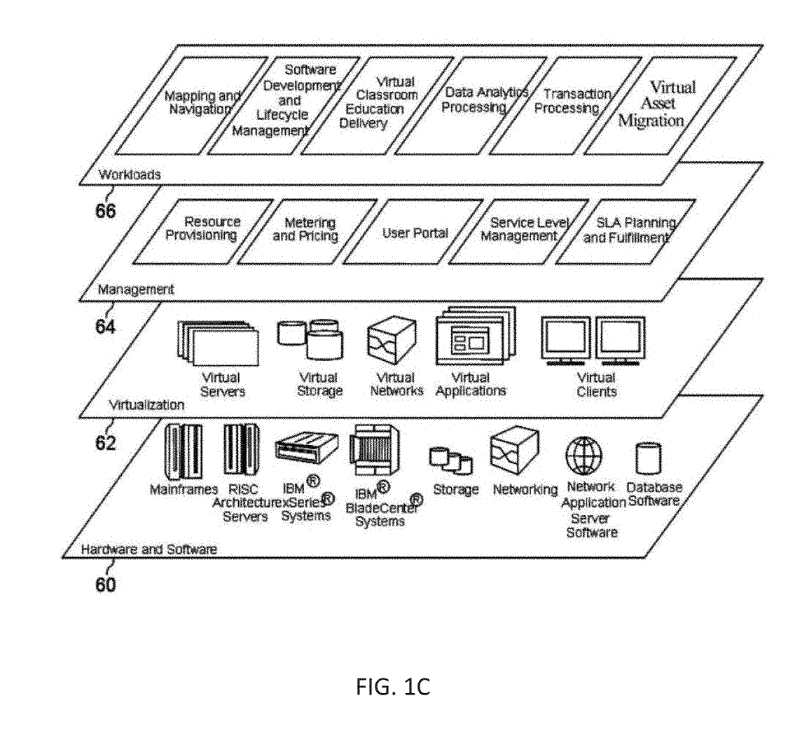

Referring now to FIG. 1A, in which an exemplary computer system/server 12 which is applicable to implement the embodiments of the present invention is shown. Computer system/server 12 is only illustrative and is not intended to suggest any limitation as to the scope of use or functionality of embodiments of the invention described herein.

As shown in FIG. 1A, computer system/server 12 is shown in the form of a general-purpose computing device. The components of computer system/server 12 can include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media can be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 can further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 can include at least one program product having a set (e.g., at least one) of program modules that are configured to carry out the functions of embodiments of the invention.

Program/utility 40, having a set (at least one) of program modules 42, can be stored in memory 28 by way of example, and not limitation, as well as an operating system, one or more application programs, other program modules, and program data. Each of the operating system, one or more application programs, other program modules, and program data or some combination thereof, can include an implementation of a networking environment. Program modules 42 generally carry out the functions and/or methodologies of embodiments of the invention as described herein.

Computer system/server 12 can also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to microcode, device drivers, redundant processing units, external disk drive arrays, RAID systems, tape drives, and data archival storage systems, etc.

Exemplary embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

A cloud computing environment is service oriented with a focus on statelessness, low coupling, modularity, and semantic interoperability. At the heart of cloud computing is an infrastructure comprising a network of interconnected nodes.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software-as-a-Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform-as-a-Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure-as-a-Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Identity-as-a-Service (IDaaS): the capability provided to the consumer is to deploy a cloud-based infrastructure a service that provides a set of identity and access management functions to target systems on customers' premises and/or in the cloud. IDaaS functionality can include, but is not limited to, (I) identity governance and administration (“IGA”)—this includes the ability to provision identities held by the service to target applications; (II) Access—this includes user authentication, single sign-on (SSO), and authorization enforcement (III) Intelligence—this includes logging events and providing reporting that can answer questions such as “who accessed what, and when.

Several different IDaaS deployment models can be employed. For instance, (I) “private cloud models” can be implemented where the cloud infrastructure is operated solely for an organization. Private clouds can be managed by the organization or a third party and may exist on-premises or off-premises. (II) The IDaaS can be deployed as a “community cloud model” where the cloud infrastructure is shared by several organizations and supports a specific community that has shared concerns (e.g., mission, security requirements, policy, and compliance considerations). Community cloud models can be managed by the organizations or a third party and may exist on-premises or off-premises. (III) “Public cloud models” can also be employed where the cloud infrastructure is made available to the general public or a large industry group and is owned by an organization selling cloud services. (IV) “Hybrid cloud models” also exist where the cloud infrastructure is a composition of two or more clouds (private, community, or public) that remain unique entities but are bound together by standardized or proprietary technology that enables data and application portability (e.g., cloud bursting for load-balancing between clouds).

Referring now to FIG. 1A, a schematic of an example of a cloud computing node is shown. Cloud computing node 10 shown in FIG. 1A is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 can be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules can be located in both local and remote computer system storage media including memory storage devices.

As shown in FIG. 1A, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to microcode, device drivers, redundant processing units, external disk drive arrays, RAID systems, tape drives, and data archival storage systems, etc.

Referring now to FIG. 1B, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1B are intended to be illustrative only and that computing nodes 10 and cloud computing environment 50 can communicate with any type of computerized device over any type of network and/or network addressable connection (e.g., using a web browser).

Referring now to FIG. 1C, a set of functional abstraction layers provided by cloud computing environment 50 (FIG. 1B) is shown. It should be understood in advance that the components, layers, and functions shown in FIG. 1C are intended to be illustrative only and embodiments of the invention are not limited thereto. As depicted, the following layers and corresponding functions are provided:

Hardware and software layer 60 includes hardware and software components. Examples of hardware components include: mainframes; RISC (Reduced Instruction Set Computer) architecture based servers; servers; blade servers; storage devices; and networks and networking components. In some embodiments, software components include network application server software and database software.

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include mapping and navigation; software development and lifecycle management; virtual classroom education delivery; data analytics processing; transaction processing; and virtual asset migration.

In the following, several terms which may be used in the specification are explained as follows.

Cloud (or cloud-side): it consists of a cloud management platform, a physical host managed by the cloud management platform and a virtual machine (VM) run on the physical host connected over a network.

Cloud computing platform: it is the cloud management platform of entire cloud-side, and is used for performing cloud processing such as storing and/or computing, etc. and issuing various instructions to the physical host managed by it. It may also be referred to as “manager” or “cloud manager”.

Physical host: it is connected with the cloud manager over a network, it is the host machine of a VM, receives various instructions of the cloud manager through a controller agent so as to run, change or stop a VM application thereon, and reports the processing result to the cloud manager.

Virtual Machine (VM): it is an application run on the physical host and may complete various tasks and functions so as to provide cloud services. The above explanation is only exemplary and does not limit the scope of the present disclosure.

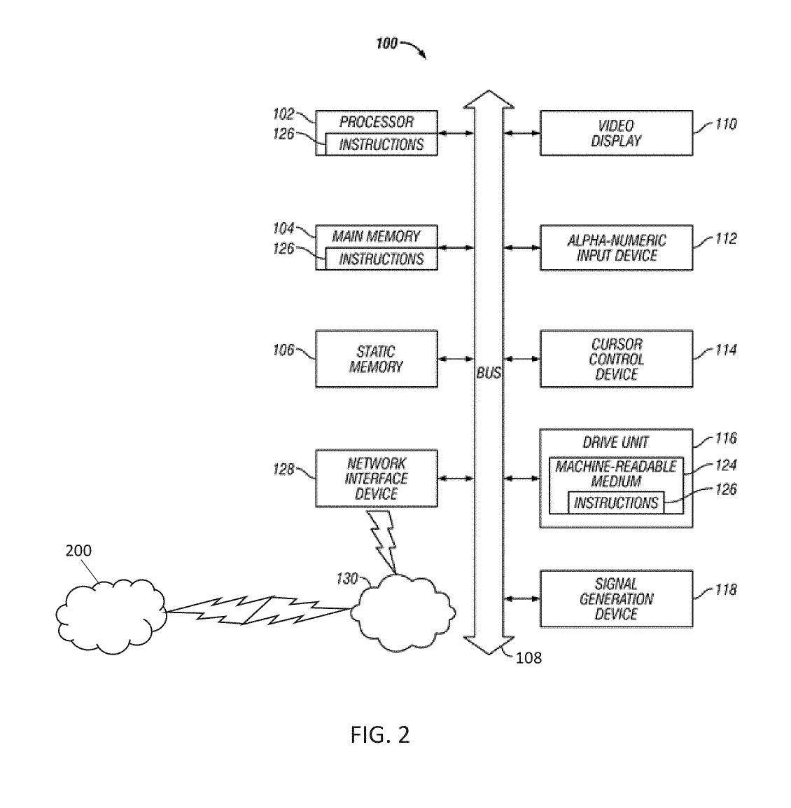

Referring now to FIG. 2, shown is a diagrammatic representation of a machine in the exemplary form of a computer system 100 within which a set of instructions for causing the machine to perform any one of the methodologies discussed herein below may be executed. In alternative embodiments, the machine may comprise a network router, a network switch, a network bridge, personal digital assistant (PDA), a cellular telephone, a web appliance or any machine capable of executing a sequence of instructions that specify actions to be taken by that machine.

The computer system 100 includes a processor 102, a main memory 104 and a static memory 106, which communicate with each other via a bus 108. The computer system 100 may further include a display unit 110, for example, a liquid crystal display (LCD) or a cathode ray tube (CRT). The computer system 100 also includes an alphanumeric input device 112, for example, a keyboard; a cursor control device 114, for example, a mouse; a disk drive unit 116, a signal generation device 118, for example, a speaker, and a network interface device 128.

The disk drive unit 116 includes a machine-readable medium 124 on which is stored a set of executable instructions, i.e. software, 126 embodying any one, or all, of the methodologies described herein below. The software 126 is also shown to reside, completely or at least partially, within the main memory 104 and/or within the processor 102. The software 126 may further be transmitted or received over a network 130 by means of a network interface device 128. The network 130 includes any suitable computer network capable of allowing a plurality of computing devices to communicate with one another. For example, the network 130 includes a local area network (LAN), wide area network (WAN), or combination thereof. The network 130 is in signal communication with a cloud-side network 200 operated by a cloud service provider.

In contrast to the system (100) discussed above, a different embodiment of the invention uses logic circuitry instead of computer-executed instructions to implement processing offers. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large scale integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like. It is to be understood that embodiments of this invention may be used as or to support software programs executed upon some form of processing core (such as the Central Processing Unit of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

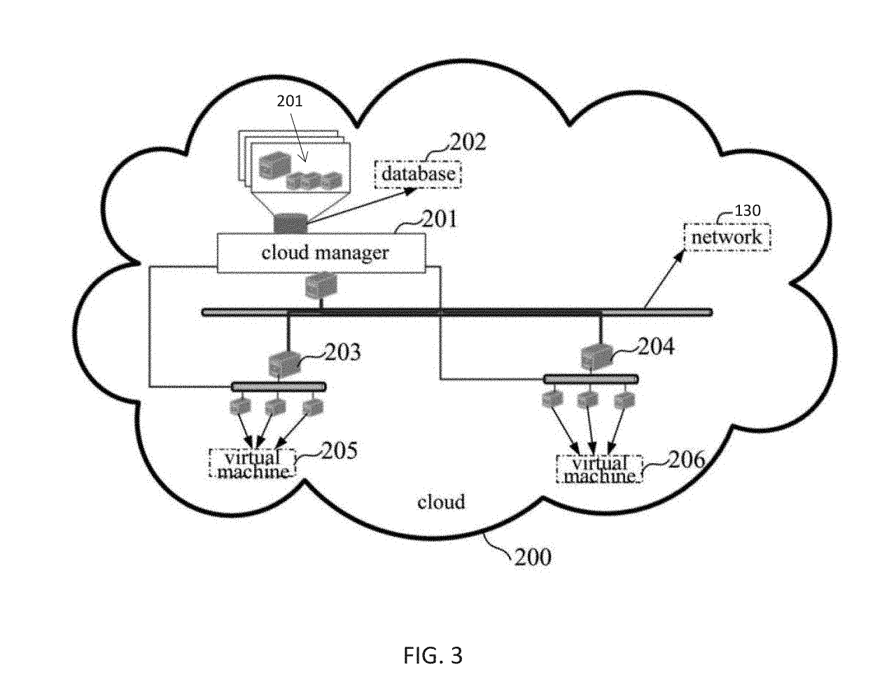

FIG. 3 illustrates a non-limiting embodiment of a basic topology of a cloud-side network 200. The basic topology of the cloud-side network 200 includes a cloud manager 201, a database 202 of the cloud manager 201, and physical hosts 203-204. The physical hosts 203-204 may include multiple virtual machines 205-206 and the network 130. The virtual machines 205-206 are run on physical hosts so as to provide one or more cloud services. The network 130 connects the cloud manager 201 and physical hosts 203-204, and also connects the cloud-side network 200 with the network 130 so as to provide the access service. The cloud manager 201 can update the database 202 with new versions of Web Application code, which can be subsequently provided to the network 130 as described in greater detail below.

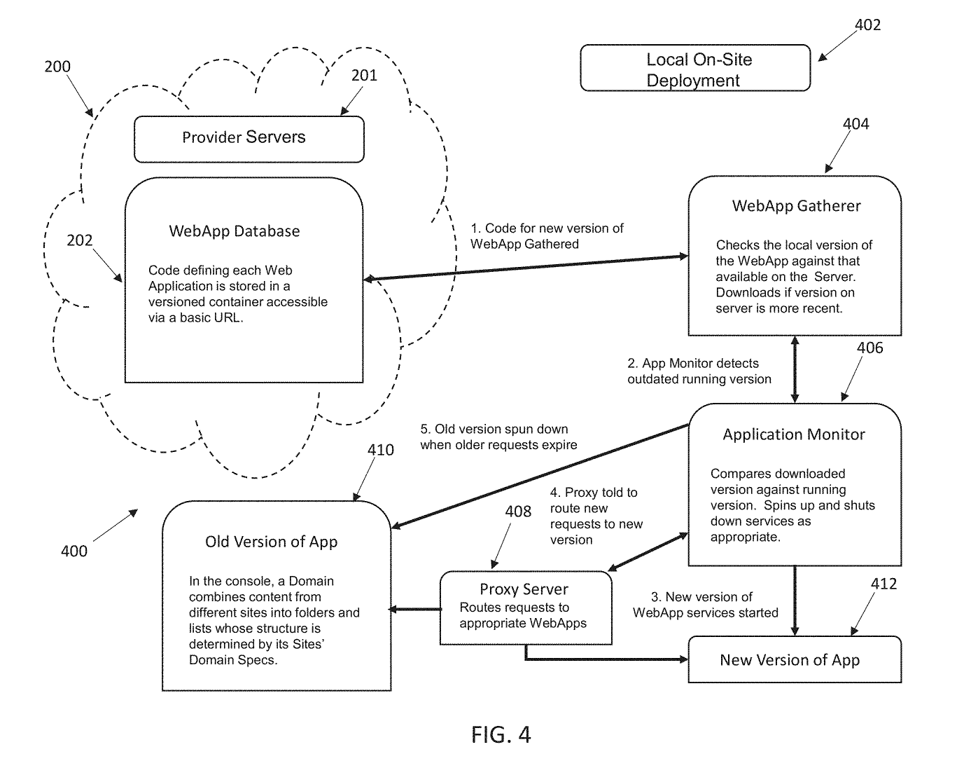

Turning now to FIG. 4, an enterprise web application management system 400 is illustrated according to a non-limiting embodiment. The web application management system 400 includes a cloud-side network 200 in signal communication with an on-site local computing network 402. The cloud-side network 200 includes one or more cloud-side service provider servers 201 which store one or more WebApp databases 202. The WebApp databases 202 are configured to store WebApp code defining a Web Application (i.e., WebApp) that is provided to the on-site local computing network 402. The WebApp code is generated at the cloud-side network 200, and each generated WebApp code is assigned a version identification (ID). For instance, the vendor of the cloud service controls when a new version of the code are pushed to the WebApp database 202. In this manner, the most recent WebApp code can be identified from among the previous WebApp code versions stored in the WebApp database 202. For instance, an initial WebApp code can be assigned a version ID of 1.0. The initial WebApp code may be subsequently updated and then assigned a version ID of 2.0. Accordingly, the WebApp code 2.0 can be identified as being the most up-to-date version of the WebApp code to be provided to the local computing network 402.

The local computing network 402 includes an electronic WebApp gatherer controller 404, an electronic application monitor controller 406, a proxy server 408, and one or more WebApps 410-412. In at least one embodiment, a customer (e.g., a manager on the on-premise local side) initially installs the web applications defined in the code repository on servers in their local environment. These web applications provide interfaces (User Interfaces or APIs) that are accessible via standard network access rules. Traffic is handled by means of a proxy server. The WebApp gatherer controller 404 is configured to establish signal communication with a cloud-side service provider server 201 to obtain WebApp code stored in the WebApp database 202. In at least one embodiment, the WebApp gatherer controller 404 accesses the WebApp database 202 via a basic Uniform Resource Identifier (URI), for example.

In at least one non-limiting embodiment, the WebApp gatherer controller 404 communicates with the cloud-side service provider server 201 and compares the version ID of the WebApp code currently installed at the local computing network 402 with the versions of WebApp codes stored in the WebApp database 202. When a version of the WebApp code stored in the WebApp database 202 is newer (i.e., more up-to-date) than the version of the WebApp database currently installed at the local computing network 402, the WebApp gatherer controller 404 automatically obtains (e.g., downloads) the most up-to-date WebApp code. In at least one embodiment, the WebApp gatherer controller 404 downloads the new up-to-date WebApp code from the WebApp database 202, and stores the downloaded up-to-date WebApp code in a WebApp on-premise repository such as an on-premise database (not shown) installed in the on-premise local network 402.

As described above, the most up-to-date version of the WebApp code can be determined by comparing the version ID of the WebApp database currently installed at the local computing network 402 with the version ID of the WebApp. Accordingly, the WebApp gatherer controller 404 determines that a WebApp software having a greater version ID is a more up-to-date version of the WebApp code. In at least one embodiment, WebApp gatherer controller 404 communicates with the cloud-side service provider server 201 according to a predetermined schedule such as, for example, once every 60 mins. This schedule can be set by a network manager on the local side. Although a particular schedule for checking the WebApp database 202 can be set manually, the actual obtaining and downloading of the newest and most up-to-date WebApp code can be automatically performed without manual intervention.

The application monitor controller 406 can access the on-premise repository and is configured to compare a version of the most recent downloaded WebApp code to the version ID of the WebApp database currently running on the local computing network 402. In at least one embodiment, the WebApp gatherer controller 404 is in signal communication with the application monitor controller and informs the application monitor controller 406 that a new version of the WebApp code exists in response to downloading the new WebApp code to the local computing network 402. The application monitor controller 406 can also repeatedly contact the WebApp gatherer controller 404 and/or access the on-premise repository according to a predetermined schedule (e.g. every 60 mins) to determine whether a new version of the current running WebApp code has been obtained by the WebApp gatherer controller 404. In response to determining that a more up-to-date WebApp code exists, the application monitor controller 406 automatically initiates a spin-up process to spin-up a new WebApp 412 based on the newest and most up-to-date WebApp code obtained by the WebApp gatherer controller 404. In at least one embodiment, the spin-up process is automatically initiated without manual intervention.

The proxy server 408 is configured to route requests to the appropriate WebApp. Prior to spinning up the new WebApp 412, the proxy server 408 is set to route requests to the previous version of the WebApp 410. In this manner, the previous version of the WebApp 410 can be utilized to continue routing requests while the application monitor controller 406 spins up the new WebApp 412. Once the new WebApp 412 is spun up and operational, the application monitor controller 406 communicates with the proxy server 408, and informs the proxy server 408 to begin routing request previously assigned to the previous WebApp 410 to the new WebApp 412. Thereafter, the application monitor controller 406 can spin down the now out-of-date WebApp 410. In at least one embodiment, application monitor controller 406 is informed by the proxy server 408 as to whether any requests to the initial WebApp 410 exist or whether no request exists. In this manner, the application monitor controller 406 can wait to spin down the initial WebApp 410 until no further requests exist. Accordingly, WebApps installed at an on-premise local computing network can be conveniently and automatically uploaded without manual intervention on the local on-site side. In this manner, customers are provided with an on-premise experience similar to that experienced with cloud-based solutions.

In a non-limiting embodiment, the enterprise management system installed on the local computing network 402 enables system administrators to manage on-premise devices, manage web applications for software distribution, and manage software patch installations. The vendor of the cloud network 200 updates the patch application with new functionality, builds the code, and stores the updated code it in the cloud-based WebApp database 202.

In the local environment, the WebApp gatherer controller 404 identifies that a newer version of the WebApp code is available and automatically downloads the new code to the on-site premise local computing network. The application monitor controller 406 spins up a new WebApp 412 using the new code downloaded to the local environment 402. In at least one embodiment, the core proxy server and software distribution applications are not updated with new code during this transition.

In another non-limiting embodiment, given the same environment mentioned above, the vendor of the cloud network 200 updates all of its applications with a new version of the web framework. These are all made available in the external repository. The WebApp gatherer controller 404 determines new versions of the WebApp code, and downloads the new code to the on-premise local network 402. The application monitor controller 406 stages the updating of each component according to dependencies defined in the downloaded content. In at least one embodiment, the proxy server itself is updated alongside the software distribution and patch management applications.

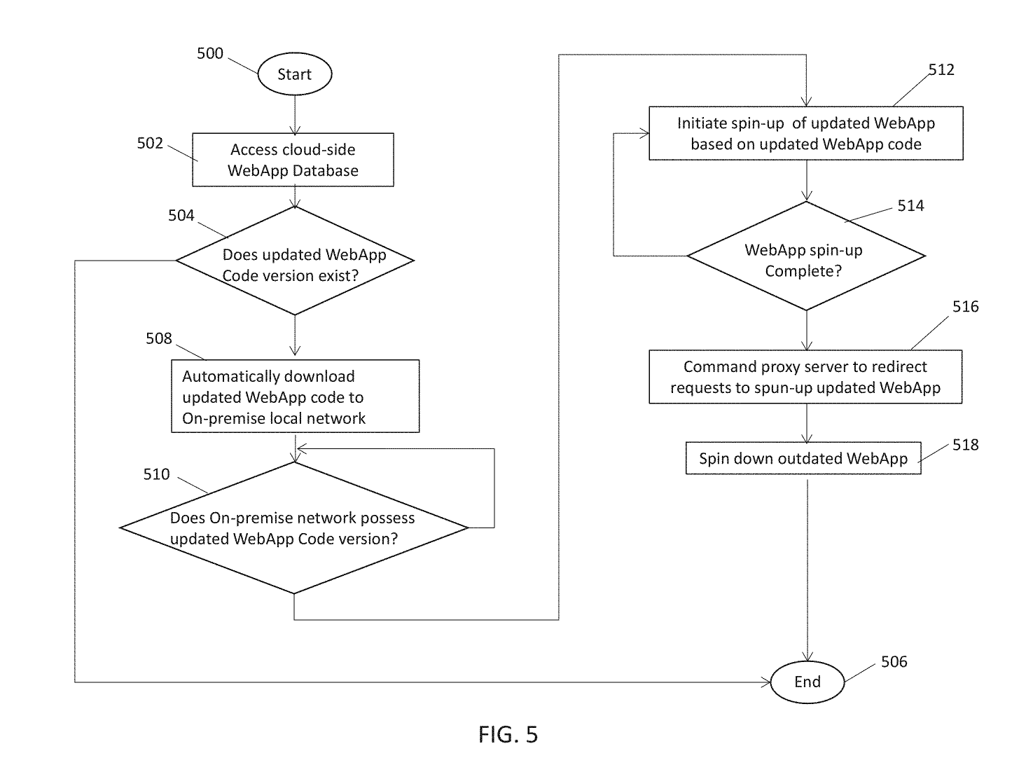

Turning now to FIG. 5, a method of managing concurrency of on-premise enterprise web applications installed on-premise is illustrated according to a non-limiting embodiment. The method begins at operation 500, and at operation 502 an on-premise local computing network accesses a WebApp database installed at a cloud-side server. At operation 504, a WebApp gatherer controller installed at the on-premise network determines if new updated WebApp code is stored in the cloud-side WebApp database. When an updated WebApp code does not exist, the method ends at operation 506. When, however, updated WebApp code exists, the WebApp gatherer controller automatically downloads the updated WebApp code from the cloud-side WebApp database to the on-premise local computing network at operation 508.

At operation 510, an application monitor controller installed on the on-premise local network communicates with the WebApp gatherer controller to determine whether an updated WebApp code has been downloaded to the on-premise local network. When an updated WebApp codes has not been downloaded, the method returns to operation 510 and continues checking whether an updated WebApp code is downloaded to the on-premise local network. When, however, updated WebApp code has been downloaded to the on-premise local network, the application monitor controller installed on the on-premise local network automatically initiates a spin-up process to spin-up a new WebApp based on the updated WebApp code at operation 512.

At operation 514, the application monitor controller monitors the status of the WebApp spin up. When the new WebApp is not completed (i.e., still being spun up), the method returns to operation 514 and continues spinning up the new WebApp. When, however, the new WebApp is completely spun up and operational, the method proceeds to operation 516, and commands the proxy server to redirect requests to the newly spun-up updated WebApp. At operation 518, the previous outdated WebApp is spun down. In at least one embodiment, the application monitor controller can automatically initiate the spin down process after commanding the proxy server to redirect requests to the new updated WebApp. After spinning down the outdated WebApp, the method ends at operation 506.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting-data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As used herein, the term “module” refers to an application specific integrated circuit (ASIC), an electronic circuit, an electronic computer processor (shared, dedicated, or group) and memory that executes one or more software or firmware programs, a combinational logic circuit, and/or other suitable components that provide the described functionality. When implemented in software, a module can be embodied in memory as a non-transitory machine-readable storage medium readable by a processing circuit and storing instructions for execution by the processing circuit for performing a method.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An enterprise web application management system, comprising:
a cloud computing network including a web application (WebApp) database configured to store WebApp code; and
an on-premise local computing network remotely located from the cloud computing network and configured to run a current WebApp based on a current WebApp code, the on-premise local computing network further configured to:
electrically communicate with the cloud computing network to determine whether the cloud computing network stores an updated version of the current WebApp code;
in response to detecting that the updated version is stored at the cloud computing network, automatically download the updated version of the WebApp code from the cloud computing network and locally store the updated version of the WebApp code at the on-premise local computing network; and
in response to storing the updated version of the WebApp code at the on-premise local computing network, automatically spin up a new WebApp based on the updated version of the WebApp code in response to locally storing the updated version of the WebApp code to the on-premise local computing network.

2. The enterprise web application management system of claim 1, wherein the on-premise local computing network comprises:
an electronic WebApp gatherer controller configured to electrically communicate with the WebApp database, and automatically transfer the updated version of the WebApp code from the cloud computing network to the on-premise local computing network without manual intervention; and
an electronic application monitor controller configured to automatically determine that the updated version of the WebApp code is stored on the on-premise local computing network, and to automatically spin up the new WebApp without manual intervention.

3. The enterprise web application management system of claim 2, wherein the WebApp gatherer controller automatically accesses the WebApp database according to a set time schedule.

4. The enterprise web application management system of claim 2, wherein the WebApp gatherer controller identifies the updated version of the WebApp code based on a comparison between a first version identification (ID) number assigned to the current version of the WebApp code and a second version ID number assigned to the updated version of the WebApp code.

5. The enterprise web application management system of claim 4, wherein the second version ID number is greater than the current version ID number.

6. The enterprise web application management system of claim 2, wherein the electronic application monitor detects completion of the spin up, and commands a proxy server to redirect requests to the a new WebApp in response to completion of the spin up.

7. The enterprise web application management system of claim 6, wherein, after requests are redirected to the new WebApp, the application monitor automatically spins down the current WebApp without manual intervention.

8. An on-premise local computing network configured to manage concurrency of an on-premise web application (WebApp), the on-premise local computing network comprising:
an electronic WebApp gatherer controller configured to electrically communicate with a WebApp database installed in a cloud computing network located remotely from the on-premise local computing network, determine whether the WebApp database stores an updated version of a WebApp code, and in response to detecting the updated version of the WebApp code, automatically transfer the updated version of the WebApp code from the cloud computing network to the on-premise local computing network without manual intervention; and
an electronic application monitor controller configured to automatically determine that the updated version of the WebApp code is locally stored on the on-premise local computing network, and to automatically spin up the new WebApp without manual intervention in response to detecting local storage of the updated version of the WebApp code.

9. The on-premise local computing network of claim 8, wherein the WebApp gatherer controller automatically accesses the WebApp database according to a set time schedule.

10. The on-premise local computing network of claim 9, wherein the WebApp gatherer controller identifies the updated version of the WebApp code based on a comparison between a first version identification (ID) number assigned to the current version of the WebApp code and a second version ID number assigned to the updated version of the WebApp code.

11. The on-premise local computing network of claim 10, wherein the second version ID number is greater than the current version ID number.

12. The on-premise local computing network of claim 10, wherein the electronic application monitor detects completion of the spin up, and commands a proxy server to redirect requests to the a new WebApp in response to completion of the spin up.

13. The on-premise local computing network of claim 12 wherein, after requests are redirected to the new WebApp, the application monitor automatically spins down the current WebApp without manual intervention.

14. A method of managing concurrency of an on-premise web application (WebApp) running on an on-premise local computing network, the method comprising:
storing WebApp code in a WebApp database of a cloud computing network;
establishing signal communication between the cloud computing network and an on-premise local computing network remotely located from the cloud computing network, and running a current WebApp based on a current WebApp code at the on-premise local computing network,
determining whether the cloud computing network stores an updated version of the current WebApp code;
in response to determining the updated version is stored at the cloud computing network, automatically transferring the updated version of the WebApp code to the on-premise local computing network and storing the updated version of the WebApp code at the on-premise local computing network; and
automatically spinning up a new WebApp based on the updated version of the WebApp code in response to storing the updated version of the WebApp code at the on-premise local computing network.

15. The method of claim 14, wherein determining whether the on-premise local computing network stores an updated version of the current WebApp code further comprises:
communicating with the WebApp database via a WebApp gatherer controller to determine whether a current version of the WebApp code stored at the on-premise network is a latest version of the WebApp code; and
in response to determining that the cloud computing network stores an updated WebApp code with respect to the current version of the WebApp code, automatically downloading, via the WebApp gatherer controller, the updated version of the WebApp code from the cloud computing network to the on-premise local computing network without manual intervention.

16. The method of claim 15, wherein automatically spinning up a new WebApp further comprises automatically spinning up, via an application monitor control, the new WebApp without manual intervention.

17. The method of claim 15, wherein the WebApp gatherer controller identifies the updated version of the WebApp code based on a comparison between a first version identification (ID) number assigned to the current version of the WebApp code and a second version ID number assigned to the updated version of the WebApp code.

18. The method of claim 17, wherein the second version ID number is greater than the current version ID number.

19. The method of claim 16, wherein the application monitor detects completion of the spin up, and commands a proxy server to redirect requests to the a new WebApp in response to completion of the spin up.

20. The method of claim 19, wherein, after requests are redirected to the new WebApp, the application monitor automatically spins down the current WebApp without manual intervention.
